(19) United States
(12) Patent Application Publication
(10) Pub. No.: US 2008/0110316 A1
(43) Pub. Date: May 15, 2008

(54) SAW CHAIN CUTTING LINK WITH TAPER

(75) Inventor: Mike Harfst, Milwaukie, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: BLOUNT, INC., A DELAWARE CORPORATION, Portland, OR (US)

(21) Appl. No.: 11/937,833

(22) Filed: Nov. 9, 2007

Related U.S. Application Data
(60) Provisional application No. 60/866,004, filed on Nov. 15, 2006.

(51) Int. Cl. B27B 33/14

(52) U.S. Cl. 83/830; 29/592

(57) ABSTRACT

Embodiments of the invention disclose a cutter link adapted to move in a cutting direction along a guide rail of a guide bar. The cutter link includes a cutting portion that tapers from a leading portion adjacent a sharpened edge to a trailing portion rearward of the leading.

### CROSS REFERENCE TO RELATED APPLICATIONS

The present application claims priority to U.S. Provisional Patent Application No. 60/866,004, filed Nov. 15, 2006, entitled “SAW CHAIN LINK WITH TAPER AND/OR OFFSET,” the entire disclosure of which is hereby incorporated by reference in its entirety.

### TECHNICAL FIELD

The present invention relates to the field of saw chains, and in particular to a saw chain having one or more cutting links having a tapered configuration.

### BACKGROUND

Chain saws typically include an endless saw chain disposed to articulate along and around a guide bar comprising various coupled links including cutter links, drive links, and tie straps. The cutter links and tie straps are typically in sliding engagement on bar rails of the saw bar. The kerf made by the saw chain in a work piece, such as a log or tree, is generally the width of the cutter link. The size and width of the chain components, in particular the width of the cutter link, generally affects the amount of power required for effective cutting. A saw chain with thinner and/or narrower cutter links would thus typically require less power, and would cut more efficiently than one with thicker or wider cutting links. Thinning and/or narrowing the cutter links, however, render them more prone to breakage under normal conditions. This is especially true as the cutting portion of the cutter link gets shorter in the longitudinal direction due to wear and repeated re-sharpenings.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a side view of a portion of a saw chain in accordance with various embodiments of the present invention;

FIG. 2 illustrates a cross-sectional view taken along the line 2-2 of FIG. 1 in accordance with various embodiments of the present invention;

FIG. 3 illustrates a cross-sectional view of a cutter link in accordance with various embodiments of the present invention;

FIG. 4 illustrates a cross-sectional view of a cutter link in accordance with various embodiments of the present invention; and

FIG. 5 is a flow chart illustrating a method in accordance with various embodiments of the present invention.

### DETAILED DESCRIPTION OF EMBODIMENTS OF THE INVENTION

In the following detailed description, reference is made to the accompanying drawings which form a part hereof, and in which are shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments in accordance with the invention may provide a saw chain that may help to reduce power consumption and improve performance when cutting material, such as wood. In various embodiments, the cutting portion of the cutting links may be tapered in order to improve performance in the chain during the earlier part of the chain life and provide sufficient strength for the cutting portion to withstand stresses during the later part of the chain life.

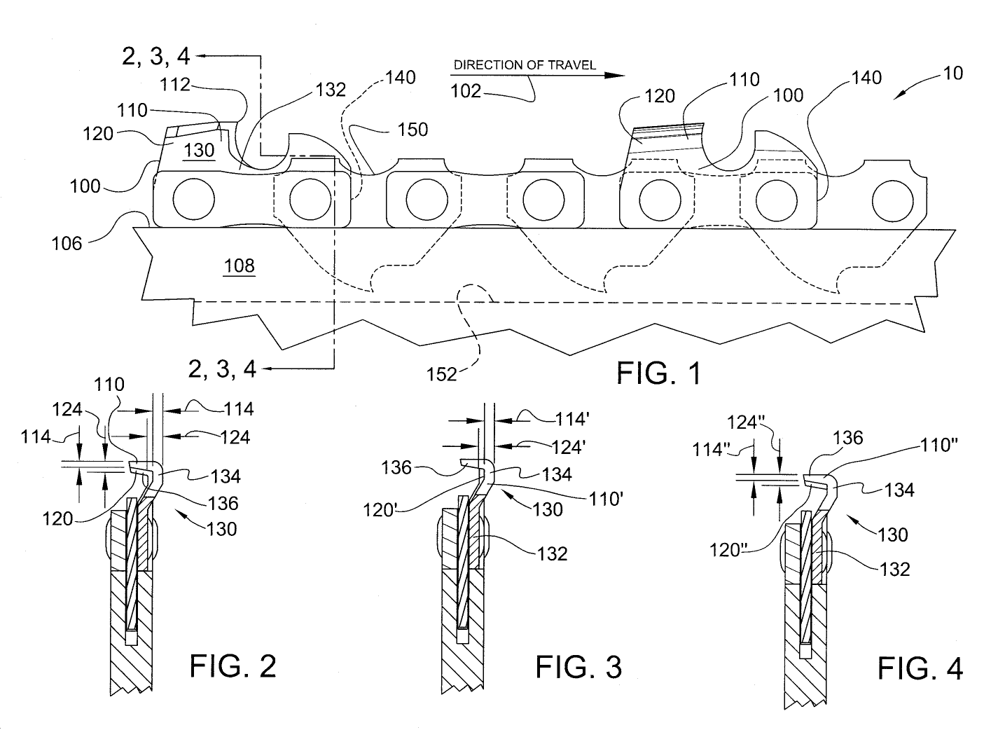

FIG. 1 is a side view of a portion of a saw chain and FIGS. 2, 3 and 4 are cross sectional views taken at the coincident lines 2-2, 3-3, and 4-4 in FIG. 1, illustrating various embodiments in accordance with the invention. A saw chain 10 may include one or more drive links 150 adapted to ride within a groove 152 of a guide bar 108. One more cutter links 100 may be coupled with the one or more drive links 150. Cutter link 100 may be adapted to move in a cutting direction, or direction of travel, as illustrated with arrow 102, along a guide rail 106 of guide bar 108.

The cutter link 100 may include a body 132 and a cutting portion 130 extending there from, and having a leading portion 110 and a trailing portion 120. A sharpened or cutting edge 112 may be adjacent to and/or part of the leading portion. Leading portion 110 may have a first thickness as illustrated with dimension 114. Trailing portion 120 may be disposed rearward of the leading portion 110 and may have a second thickness as illustrated with dimension 124. The first thickness 114 may be less than the second thickness 124. In various embodiments, the dimension of the first thickness may gradually increase and/or taper towards the second thickness as portions of the cutting edge 112 is removed during the life of the chain.

In various embodiments, the thinner leading portion 110 may allow the cutting edge 112 to more efficiently cut with less power required in order to remove substantially the same amount of material. Through use of the saw chain 10 the cutting edge 112 may need to be re-sharpened from time to time. With each re-sharpening the sharpened edge 112 may migrate rearward, thereby shortening the longitudinal dimension of the cutting portion 130. Because the trailing portion 120 may be thicker (e.g. similar in thickness to the cutting portions on current cutter links) relative to the leading portion 110, as the longitudinal length of the cutter portion 130 of cutter link 100 shortens, the cutter portion 130 may be better equipped to withstand the stresses encountered, and may better withstand shearing. As the cutting edge 112 moves rearward, the thickness of the leading portion 110 and cutting edge 112 may approach the thickness of the trailing portion 120. Thus towards the end of life, a stronger cutting portion may be provided to better withstand stresses; whereas towards the beginning of chain life the thinner leading portion may be sufficiently strong due to the support of the longer cutting portion 130, and yet remain more efficient than a standard uniform thickness.

In various embodiments, the cutting edge 112 may include a side cutting element 134 and/or an upper cutting element 136, either or both of which may be tapered to improve performance and efficiency. For example, as illustrated in FIG. 3, the side cutting element 134 may have a side leading portion 110′ that may have a side first thickness 114′, and may also have a side trailing portion 120′ that may have a side second thickness 124′. As illustrated, the upper cutting edge 136 is not tapered throughout the cutting portion 130. FIG. 4 illustrates an example of cutting portion 130 where the upper cutting element 136 is tapered and the side cutting element is not. As illustrated the upper cutting element 136 may have a leading portion 110″ that may have a first thickness 114″, and may also have a trailing portion 120″ that may have a second thickness 124″. The upper element first thickness 114″ being thinner than upper element second thickness 124″.

In various embodiments, as exemplified in FIG. 2, both the upper cutting element 136 and side cutting element 134 of the cutting portion 130 may be tapered or have a different thickness at the leading portion 110 than at the trailing portion 120. In various embodiments the taper and/or thickness differential between the leading portion and trailing portion of the side cutting element 134 and/or the upper cutting element 136 may be the same or may be different depending on the cutting environment. In one embodiment, the taper may be substantially continuous and uniform from the leading portion 110 to the trailing portion 120. Other embodiments the taper may be generally non-continuous and/or non-uniform from a leading portion 110 to a trailing portion 120. In one embodiment, the taper may include the cutting portion having an inner or first planar surface disposed at differing angles with respect to an outer planar surface of the cutting portion. Thus as the leading portion is worn away and moves toward the trailing portion, the angle may change.

It should be noted that taper in the broad sense as a change in dimension over a determined distance. Further, while it is recognized that a sharpened edge itself of a cutter link has a change in thickness at the face of the cutting edge, it will be appreciated that this change of dimension is not the same as the change in dimension of the overall cutter portion as set forth in various embodiments of the present invention.

In various embodiments the cutter link may be made from a material having a thinner leading edge, which tapers towards a rear portion of the cutter. The cutter link may be made from such material using, for example, a stamping, coining and/or other operation. In one embodiment, when the leading portion of the cutting portion may have a thickness within a range of about 0.035 inches to about 0.050 inches and the trailing portion may have a thickness within a range of about 0.040 inches to about 0.060 inches. In one embodiment, when the saw chain is in a new condition, the leading portion of the cutting portion may have a thickness of about 0.040 inches, and the trailing portion may have a thickness of about 0.050 inches. In various embodiments the width of the body of the cutter link may also taper from being thinner at a forward portion to thicker at the rearward portion.

Various other embodiments may provide a cutter link having a reverse taper from the leading portion to the trailing portion; i.e. thicker in the leading portion and thinner in the trailing portion. Such a configuration may be appropriate where a chain has some difficulty in exhausting the wood chips from underneath the upper cutter element, which may also be referred to as the cutter hood. This can be due to a tall chain chassis combined with a longer cutter portion, a low cutter or some combination of design features. In such a case the chain may benefit from having a reverse bell mouth effect where the taper on the side cutter element may be reversed, which in turn may allow a bigger “chip channel” to improve the ability of the chips to move past the cutter.

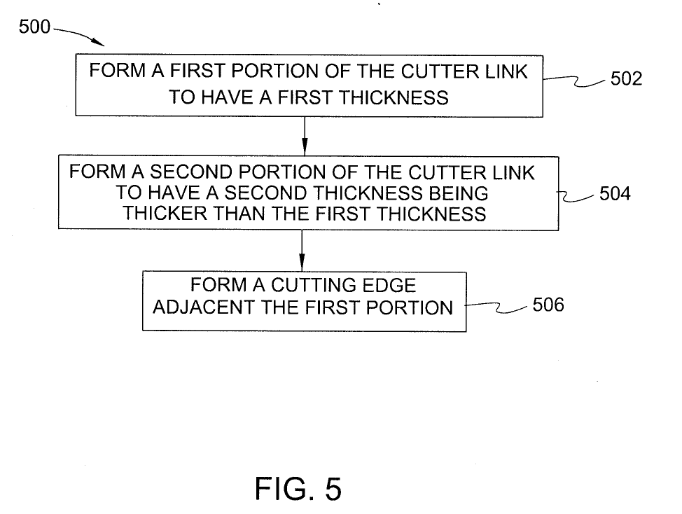

FIG. 5 is a flow chart illustrating a method 500 in accordance with various embodiments of the invention. The method 500 may include:

forming a first portion of the cutter link to have a first thickness, 502;

forming a second portion of the cutter link to have a second thickness being thicker than the first thickness, 504; and

forming a cutting edge adjacent the first portion, 506. The operations described may be performed in various orders.

In various embodiments forming the first portion may include a side cutting edge extending from a body of the cutter link and an upper cutting edge element coupled to the side cutting edge. In some embodiments forming the first portion may be on the upper cutting edge, the side cutting edge and/or both the side cutting edge and the upper cutting edge

In various embodiments forming the first portion and the forming the second portion may be a substantially continuous forming such that the cutter link has a continuous change of thickness from the first portion to the second portion. In other embodiments forming the first portion and forming the second portion may form a non continuous and/or non uniform change of thickness from the first portion to the second portion.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A cutter link adapted to move in a cutting direction along a guide rail of a guide bar comprising:
a body; and
a cutting portion having a leading portion adjacent a sharpened edge and a trailing portion rearward of the leading portion, the leading portion having a first thickness and the trailing portion having a second thickness that is different than the first thickness.

2. The cutter link of claim 1, wherein the first thickness is less than the second thickness.

3. The cutter link of claim 1 wherein the cutting portion includes
a side cutting element extending from the body;
a upper cutting element extending from the side cutting element; and
wherein the leading portion having the first thickness and the trailing portion having the second thickness is on the upper cutting element, the side cutting element, and/or both the upper cutting element and the side cutting element.

4. The cutter link of claim 1, wherein the first thickness is in the range of about 0.035 inches to about 0.050 inches and the second thickness is in the range of about 0.040 inches to about 0.060 inches.

5. The cutter link of claim 1, wherein the first thickness is about 0.040 inches and the second thickness is about 0.050 inches.

6. The cutter link of claim 1 wherein the cutter link tapers substantially continuously from the leading portion to the trailing portion.

7. The cutter link of claim 1 wherein the cutter link tapers in a substantially non-continuous manner from the leading portion to the trailing portion.

8. The cutter link of claim 7 wherein the substantially non-continuous manner of the taper includes an inner planar surface of the cutting portion disposed at differing angles with respect to an outer planar surface of the cutting portion as the leading portion moves toward the trailing portion.

9. A method of forming a cutter link comprising:
forming a first portion of the cutter link to have a first thickness;
forming a second portion of the cutter link to have a second thickness being thicker than the first thickness; and
forming a cutting edge adjacent the first portion.

10. The method of claim 9 wherein the forming the first portion includes forming a side cutting element and an upper cutting element.

11. The method of claim 10 wherein the forming the first portion is on the upper cutting element.

12. The method of claim 10 wherein the forming the first portion is on the side cutting element.

13. The method of claim 9 wherein the forming the first portion and the forming the second portion is a substantially continuous forming such that the cutter link has a continuous change of thickness from the first portion to the second portion.

14. The method of claim 9 wherein the forming the first portion and the forming the second portion forms a non-continuous change of thickness from the first portion to the second portion.

15. A saw chain comprising
one or more drive links adapted to ride a within a groove of a guide bar;
one more cutter links coupled with the one or more drive links, each cutter link having a body and a cutting portion, the cutting portion including a leading portion adjacent a sharpened edge and a trailing portion, the cutting portion having a side cutting element having a first side thickness at the leading portion and a second side thickness at the trailing potion, the cutting portion having an upper cutting element having an upper first thickness at the leading portion and an upper second thickness at the trailing portion; and
wherein the upper first thickness is less than the upper second thickness and/or the first side thickness is less than the second side thickness.

16. The saw chain of claim 15 wherein the cutter link tapers in a substantially continuous manner from the upper first thickness to the upper second thickness and/or from the side first thickness to the side second thickness.

17. The saw chain of claim 15 wherein the cutter link tapers in a substantially non-continuous manner from the upper first thickness to the upper second thickness and/or from the side first thickness to the side second thickness.

18. The cutter link of claim 15, wherein the at least one of the side first thickness and upper first element is in the range of about 0.035 inches to about 0.050 inches and at least one of the side second thickness and the upper second thickness is in the range of about 0.040 inches to about 0.060 inches.

19. The cutter link of claim 15, wherein the at least one of the side first thickness and upper first element is about 0.040 inches and at least one of the side second thickness and the upper second thickness is about 0.050 inches.
